(19) United States
(12) Patent Application Publication
(10) Pub. No.: US 2007/0097431 A1
(43) Pub. Date: May 3, 2007

(54) Print control system and program

(75) Inventors: Makoto Matsuda, North Brunswick, NJ (US); Kazuma Aoki, Kasugai (JP); Satoshi Watanabe, Kasugai (JP); Masashi Suzuki, Nagoya (JP); Kiyotaka Ohara, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/589,791

(22) Filed: Oct. 31, 2006

(30) Foreign Application Priority Data
Oct. 31, 2005 (JP) 2005-317055

(51) Int. Cl. G06F 3/12

(52) U.S. Cl. 358/1.15; 358/1.13

(57) ABSTRACT

A print control system comprises a data obtaining system configured to obtain moving image data from a storage device that stores the moving image data including a plurality of frame data corresponding to still images, each of the plurality of frame data to which priority information representing a priority is added, a selecting system configured to select frame data to be printed based on the priority information added to each of the plurality of frame data among the plurality of frame data included in the moving image data, a data conversion system configured to generate print image data with a print image corresponding to each of the frame data selected by the selecting system being arranged on a paper, and a controlling system configured to control a printing device to form a print image based on the print image data generated by the data conversion system.

### CROSS-REFERENCE TO RELATED APPLICATION

This application claims priority under 35 U.S.C. §119 from Japanese Patent Application No. 2005-317055, filed on Oct. 31, 2005. The entire subject matter of the application is incorporated herein by reference.

### BACKGROUND

1. Technical Field

The following description relates to one or more print control systems applied for printing of moving image data and programs used for the print control systems.

2. Related Art

Recently, accompanied by an improved communication technique, an infrastructure that makes fast communication possible has been established, and thereby various contents including moving image data, incorporated into web pages, are often provided to a client device from a web server on an internet. There are known as the moving image data animation image data configured with a combination of a plurality of still image data based on the GIF standard as well as moving image data based on the MPEG standard. The animation image data based on the GIF standard are widely utilized as image data for advertisement purposes.

In the meantime, conventionally, when printing a web page into which the moving image data are incorporated on a printing paper, one of the still image data included in the moving image data is printed on the printing paper as an image corresponding to the moving image data as disclosed in Japanese Patent Provisional Publication No. 2000-163243.

However, according to a conventional printing device, when printing the web page into which the moving image data are incorporated, there are printed on the printing paper, among the plurality of still image data (frame data) included in the moving image data, still image data at the head in a reproduction order or still image data displayed on a monitor at a moment when a printing instruction has been inputted by a user. For this reason, the aforementioned operation of the conventional printing device sometimes causes disadvantage for a provider of the web page.

In other words, although the moving image data include still image data with a message that the provider wishes to convey to the user and still image data without such a kind of message, the conventional printing device prints one of the plurality of still image data included in the moving image data on the printing paper without considering an importance level of each of the plurality of still image data. Therefore, the message that the provider wishes to convey to the user with the moving image data has not sometimes been conveyed to the user with a printed still image obtained after the moving image data have been printed on the printing paper. Accordingly, so far, even though the moving image data for advertisement purposes are provided to the user through the web page into which the moving image data are incorporated, advertising effectiveness brought after the web page has been printed might be reduced.

### SUMMARY

Aspects of the present invention are advantageous in that there can be provided one or more improved techniques that make it possible to preferentially print, on a printing paper, still image data on which a creator of moving image data especially puts a priority among a plurality of still image data included in the moving image data.

### BRIEF DESCRIPTION OF THE ACCOMPANYING DRAWINGS

FIG. 1 is a block diagram showing a configuration of a communication system in accordance with one or more aspects of the present invention.

FIG. 2A is an illustration exemplifying a source of a web page provided in a web server in accordance with one or more aspects of the present invention.

FIG. 2B is an illustration showing a display screen image of the web page in accordance with one or more aspects of the present invention.

FIG. 3 is an illustration showing a configuration of animation image data in accordance with one or more aspects of the present invention.

FIG. 4 is a flowchart showing an operation accepting process to be executed by a CPU of an MFP in accordance with one or more aspects of the present invention.

FIG. 5 is a flowchart showing a moving image print setting process to be executed by the CPU of the MFP in accordance with one or more aspects of the present invention.

FIG. 6 is an illustration showing a configuration of a moving image print setting screen in accordance with one or more aspects of the present invention.

FIG. 7 is a flowchart showing a received data printing process to be executed by the CPU of the MFP in accordance with one or more aspects of the present invention.

FIG. 8 is a flowchart showing a data conversion process to be executed by the CPU of the MFP in accordance with one or more aspects of the present invention.

FIG. 9 is a flowchart showing a moving image conversion process to be executed by the CPU of the MFP in accordance with one or more aspects of the present invention.

FIG. 10 is a flowchart showing a representative layout process to be executed by the CPU of the MFP in accordance with one or more aspects of the present invention.

FIG. 11 is an illustration showing configurations of a display image and print image of the web page in accordance with one or more aspects of the present invention.

FIG. 12 is a flowchart showing a priority layout process to be executed by the CPU of the MFP in accordance with one or more aspects of the present invention.

FIG. 13 is a flowchart showing an all images layout process to be executed by the CPU of the MFP in accordance with one or more aspects of the present invention.

FIG. 14 is an illustration showing configurations of a display image and print image of the web page in accordance with one or more aspects of the present invention.

FIG. 15A is an illustration showing configurations of a display image and print image of the web page in accordance with one or more aspects of the present invention.

FIG. 15B is an illustration showing another configuration of the print image corresponding to the display image of the web page shown in FIG. 15A.

FIG. 16 is a flowchart showing a one-line layout process to be executed by the CPU of the MFP in accordance with one or more aspects of the present invention.

FIG. 17 is an illustration showing configurations of a display image and print image of the web page in accordance with one or more aspects of the present invention.

FIG. 18A is an illustration showing configurations of a display image and print image of the web page in accordance with one or more aspects of the present invention.

FIG. 18B is an illustration showing another configuration of the print image corresponding to the display image of the web page shown in FIG. 18A.

FIG. 19 is a flowchart showing a browser process to be executed by a CPU of a PC in accordance with one or more aspects of the present invention.

FIG. 20 is a flowchart showing a web page printing process to be executed by the CPU of the PC in accordance with one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

General Overview

According to aspects of the present invention, there is provided a print control system, which comprises: a data obtaining system configured to obtain moving image data from a storage device that stores the moving image data including a plurality of frame data corresponding to still images, each of the plurality of frame data to which priority information representing a priority is added; a selecting system configured to select frame data to be printed based on the priority information added to each of the plurality of frame data among the plurality of frame data included in the moving image data; a data conversion system configured to generate print image data with a print image corresponding to each of the frame data selected by the selecting system being arranged on a paper; and a print controller configured to control a printing device to form a print image based on the print image data generated by the data conversion system.

In the print control system, based on the priority information added to each of the frame data included in the moving image data, frame data to be printed on the paper are determined, and still images represented by the determined frame data are formed on the paper. Therefore, still images that are especially considered important by a creator of the. moving image data are preferentially formed on the paper. Hence, according to some aspects of the present invention, a message that the creator of the moving image data wishes to convey can be conveyed to a user with the paper on which the still images representative of the moving image data are printed. Thereby, regarding the moving image data for advertisement purposes, there is expected even in the printed paper sufficient advertising effectiveness of a product introduced in the moving image data on the user.

In particular, according to some aspects of the present invention, based on the priority information added to each of the frame data, frame data to be printed are determined, and a print image corresponding to each of the frame data is formed on the paper. Therefore, even though the still images corresponding to all of the frame data included in the moving image data are not formed on the paper, the message that the creator of the moving image data wishes to convey can be conveyed with the printed still images. Accordingly, the message represented by the moving image data can efficiently be conveyed with the printed paper without wasting a space on the paper.

It is noted that the aforementioned selecting system may only be configured to select frame data to be printed based on the priority information, and the frame data to be printed are not necessarily selected such that all of the frame data to be printed have higher priorities than those of frame data not to be printed. However, preferably, the selecting system may be configured to select a predetermined amount of frame data in sequence from frame data of a higher priority as frame data to be printed among the plurality of frame data included in the moving image data. According to the selecting system thus configured, the aforementioned effects can be further exerted.

Further, the selecting system may be configured to select a predetermined rate of frame data as frame data to be printed from the frame data included in the moving image data, or to select a predetermined number of frame data. In addition, the selecting system may be configured to select frame data of an amount determined according to an instruction by the user as frame data to be printed.

Namely, optionally, the print control system may further comprises: a user interface configured to issue a signal in accordance with a user operation; and a setting system configured to set an amount of frame data to be selected as frame data to be printed based on the signal issued from the user interface. In this case, the selecting system may be configured to select frame. data of the amount set by the setting system as frame data to be printed among the plurality of frame data included in the moving image data. According to the print control system, since still images of an amount to meet a user's requirement corresponding to the moving image can be formed on the paper, it is convenient for the user.

Optionally, the selecting system may be configured to select frame data of the highest priority as frame data to be printed among the plurality of frame data included in the moving image data.

According to another aspect of the present invention, there is provided a print control system, which comprises: a storage device configured to store contents data that include moving image data configured with a plurality of frame data corresponding to still images, priority information representing a priority being added to each of the plurality of frame data; a data obtaining system configured to obtain moving image data from a storage device that stores contents data including the moving image data configured with a plurality of frame data corresponding to still images, each of the plurality of frame data to which priority information representing a priority is added; a data detecting system configured to detect the moving image data configured with the plurality of frame data to which the priority information is added from the contents data obtained by the data obtaining system; a selecting system configured to select frame data to be printed based on the priority information added to each of the plurality of frame data among the plurality of frame data included in the moving image data; a data conversion system configured to generate print image data with a print image corresponding to each of the frame data selected by the selecting system from the plurality of frame data included in the moving image data as a print image representative of the moving image data detected by the data detecting system being arranged on a paper; and a controlling system configured to control a printing device to form a print image based on the print image data generated by the data conversion system.

According to some aspects of the present invention, when printing the contents data such as a web page, there are formed on the paper still images corresponding to the frame data selected based on the priority information added to each of the frame data included in the moving image data as images representative of the moving mage data included in the contents data.

Therefore, according to the print control system, still images that are especially considered important by the creator of the moving image data are preferentially formed on the paper as images corresponding to the moving image data included in the contents data. Hence, the message that the creator of the moving image data wishes to convey can be conveyed to the user with the paper on which the still images representative of the moving image data are printed. Thereby, according to some aspects of the present invention, there is expected even in the paper on which the contents data are printed sufficient advertising effectiveness of a product introduced in the contents data on the user.

According to a further aspect of the present invention, there is provided a computer usable medium comprising computer readable instructions that cause a computer to serve as: a data obtaining system configured to obtain moving image data from a storage device that stores the moving image data including a plurality of frame data corresponding to still images, each of the plurality of frame data to which priority information representing a priority is added; a selecting system configured to select frame data to be printed based on the priority information added to each of the plurality of frame data among the plurality of frame data included in the moving image data; a data conversion system configured to generate print image data with a print image corresponding to each of the frame data selected by the selecting system being arranged on a paper; and a controlling system configured to control a printing device to form a print image based on the print image data generated by the data conversion system.

According to the computer usable medium, the aforementioned print control system can be established, and thereby, the message that the creator of the moving image data wishes to convey with the moving image data can sufficiently be conveyed to the user with the paper on which the still images corresponding to the moving image data are printed.

According to a further aspect of the present invention, there is provided a computer usable medium comprising computer readable instructions that cause a computer to serve as: a storage device configured to store contents data that include moving image data configured with a plurality of frame data corresponding to still images, priority information representing a priority being added to each of the plurality of frame data; a data obtaining system configured to obtain moving image data from a storage device that stores contents data including the moving image data configured with a plurality of frame data corresponding to still images, each of the plurality of frame data to which priority information representing a priority is added; a data detecting system configured to detect the moving image data configured with the plurality of frame data to which the priority information is added from the contents data obtained by the data obtaining system; a selecting system configured to select frame data to be printed based on the priority information added to each of the plurality of frame data among the plurality of frame data included in the moving image data; a data conversion system configured to generate print image data with a print image corresponding to each of the frame data selected by the selecting system from the plurality of frame data included in the moving image data as a print image representative of the moving image data detected by the data detecting system being arranged on a paper; and a controlling system configured to control a printing device to form a print image based on the print image data generated by the data conversion system.

According to the computer usable medium, the print control system configured as above can be established, and thereby, when printing the contents data, still images that are especially considered important by the creator of the moving image data are preferentially formed on the paper as images corresponding to the moving image data included in the contents data. Therefore, according to some aspects of the present invention, the message that the creator of the moving image data wishes to convey with the moving image data can sufficiently be conveyed to the user with the paper on which the still images corresponding to the moving image data are printed.

Illustrative Aspects

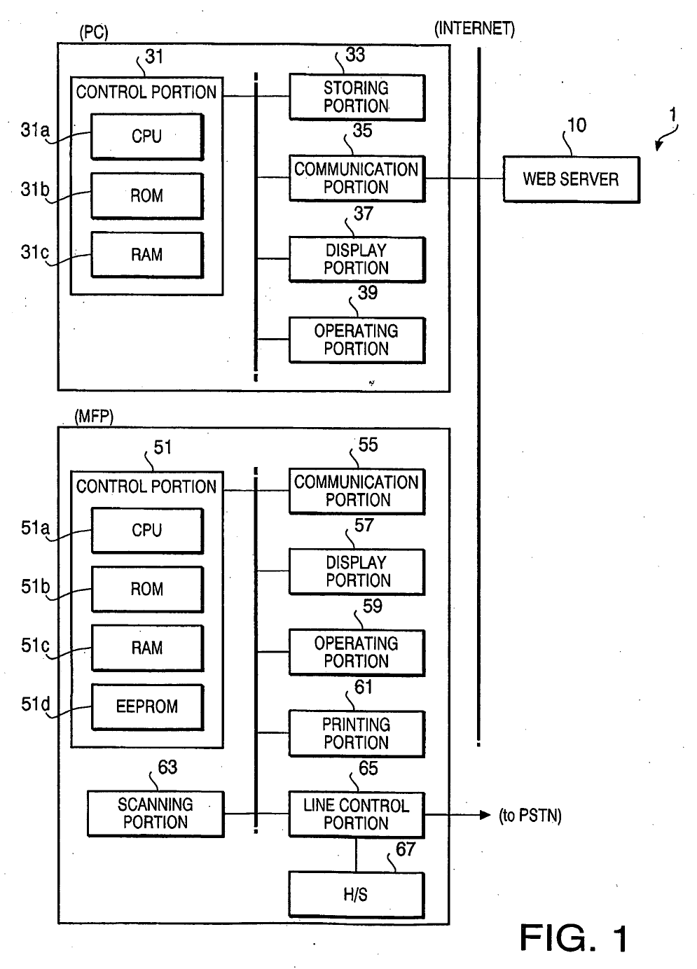

Hereinafter, illustrative aspects according to the present invention will be described with reference to the accompanying drawings. FIG. 1 is a block diagram showing a configuration of a communication system 1 to which the present invention is applied. As shown in FIG. 1, the communication system 1 in the illustrative aspect is configured with a web server 10, personal computer (hereinafter, referred to as a “PC”) 30, and digital Multi Function Peripheral (hereinafter, simply referred to as an “MFP”) 50 being communicably interconnected via an internet as a wide-area network.

The web server 10 is a server device that provides various contents as web pages to a requesting source device that requests the contents. The web server 10 has the same hardware configuration as a widely known web server, and executes a web server program with a CPU (not shown). By executing the program, the web server 10 receives a request command sent from an external device via the internet for requesting a web page, reads out a corresponding web page in accordance with a URL specified by the request command from a database (not shown) of the web server 10, and sends the read web page as response data to the requesting source device.

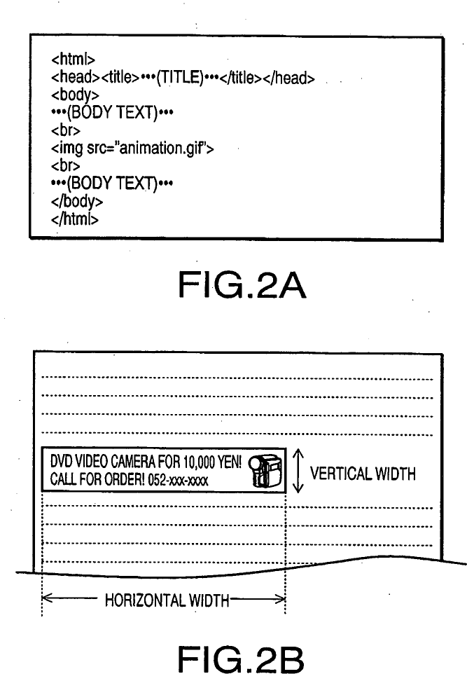

For example, when having received the request command for requesting the web page from the external device, the web server 10 reads out the corresponding web page into which animation image data are incorporated from the database thereof, and then sends the read web page as response data to the requesting source device. FIG. 2A shows an example of a source of the web page into which the animation image data are incorporated. FIG. 2B shows a display screen image of the web page corresponding to FIG. 2A. It is noted that, as is generally known, when sending and receiving the web page, an HTML (Hyper Text Markup Language) document and image data incorporated therein are sent and received in stages between the web server 10 and PC 30. In the illustrative aspect, the aforementioned operations are included in expressions “send the web page” and “receive the web page”.

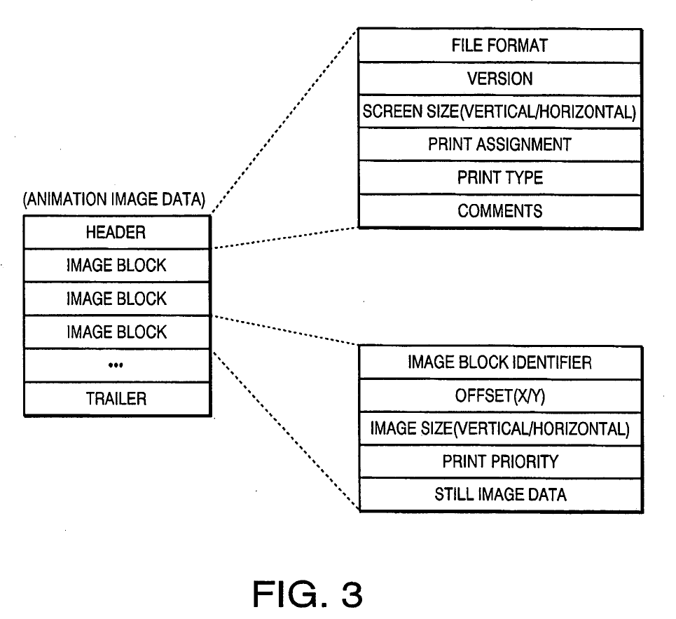

Further, in the illustrative aspect, the animation image data handled by the web server 10 are configured as shown in FIG. 3. FIG. 3 is an illustration showing a configuration of the animation image data with which the web server 10 is provided. As shown in FIG. 3, the animation image data with which the web server 10 is provided include a header portion, image blocks, and a trailer portion representing an end of the animation image data.

The header portion is configured with information representing a file format (data standard), information representing a version of the file format, screen size information representing vertical and horizontal widths of a screen on which the animation image is displayed (see FIG. 2), print assignment information representing whether to print the image data, print type information specifying a printing method for the image data, and information representing a comment being arranged in sequence. The animation image data with which the web server 10 is provided, especially, have a structure with a code representing that the image data are animation image data having print priority information described below as the information representing the file format, and a code specifying one of printing methods “representative print” and “priority print” as the print type information.

In addition, the image block, which includes still image data as frame data constituting one frame of the animation image, is configured with an image block identifier representing a start of the image block at a head of the data, offset information representing a layout location of the still image on a screen following the image block identifier, image size information representing vertical and horizontal widths of the still image, the print priority information, and further following them, the still image data being arranged in sequence. It is noted that the print priority information is information representing still image data to be preferentially printed, which is configured with a numerical value representing the priority.

Further, the image blocks configured as above of the number corresponding to the number of the frames of the animation image are provided in the animation image data. The animation image data provided in the web server 10 are configured with the header portion, the image blocks for respective frames, and the trailer portion.

Next, a configuration of the PC 30 will be explained. As shown in FIG. 1, the PC 30 is configured with a control portion 31 that includes a CPU 31a configured to execute various arithmetic processing, a ROM 31b configured to store a boot program and the like, and a RAM 31c as a working memory; a storing portion 33 configured with a hard disk drive to store various application programs such as a browser; a communication portion 35, connected with an internet, which can communicate with devices connected with the internet; a display portion 37 configured with a liquid crystal display (LCD) or the like; and an operating portion 39 configured with user-operable devices such as a keyboard and pointing device.

When a boot instruction for booting the browser is inputted with the operating portion 39 being operated by a user, the PC 30 executes the browser stored in the storing portion 33 with the CPU 31a, and displays a browser screen image as a graphical user interface (GUI) on the display portion 37. Then, according to information regarding an input operation on the browser screen through the operating portion 39, the PC 30 obtains a web page corresponding to a URL designated by the user from a web server (web server 10) specified by the URL, and displays the obtained web page on the browser screen. In addition, when a print instruction for user data (document data or web page) with which the browser or another application program deals is inputted with the operating portion 39 being operated by the user, the CPU 31a of the PC 30 converts the user data into Page Description Language. (PDL) data representing a print image to input the MFP 50 via the communication portion 35.

In addition, the MFP 50 that receives the PDL data is provided with a control portion 51 that includes a CPU 51a configured to execute various arithmetic processing, a ROM 51b configured to store various programs, a RAM 5ic as a working memory, and an EEPROM 51d for storing setting information; a communication portion 55 connected with the internet that is configured to communicate with the devices connected with the internet; a display portion 57 for displaying information; an operating portion 59 configured with various operating keys; a printing portion 61; a scanning portion 63; a line control portion 65 connected with a public switched telephone network (PSTN) that is configured to communicate with external facsimile machines and telephone devices; and a handset configured with a microphone and speaker for a voice communication.

The printing portion 61 is controlled by the control portion 51 to take in a printing paper set in a paper feeding portion (not shown) from the paper feeding portion and form a print image on the printing paper in an inkjet method or a laser printer method. The scanning portion 63 is controlled by the control portion 51, and optically reads a manuscript set in an ADF device (auto document feeder) or a manuscript set on a platen glass to generate image data representing the manuscript.

The MFP 50 in the illustrative aspect controls each of the portions such as the printing portion 61, scanning portion 63, communication portion 55, and line control portion 65 provided in the MFP 50 with programs stored in the ROM 51b being executed by the CPU 51a, so that various functions such as a printer function, scanner function, copy function, facsimile function, telephone function, and web page print function can thereby be actualized.

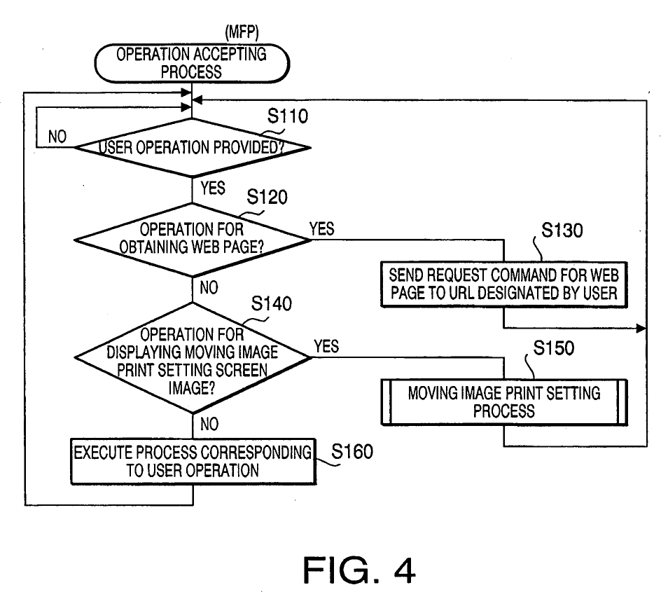

Subsequently, processes that the control portion 51 of the MFP 50 is to execute based on programs with the CPU 51a. FIG. 4 is a flowchart showing an operation accepting process to be executed by the CPU 51a of the MFP 50 when booting the MFP 50.

When starting the operation accepting process, the CPU 51a keeps waiting ready until a user operation is provided through the operating portion 59 (S110). When the user operation is provided through the operating portion 59 (S110: Yes), it is judged whether the operation is for obtaining a web page (S120). Then, when it is judged that the operation is for obtaining a web page (S120: Yes), the process goes to a step of S130 to send a request command for requesting a web page corresponding to a URL designated by the user of the web server 10 specified by the URL. Thereafter, the process goes to the step of S110, and the CPU 51a keeps waiting ready until a next user operation is provided.

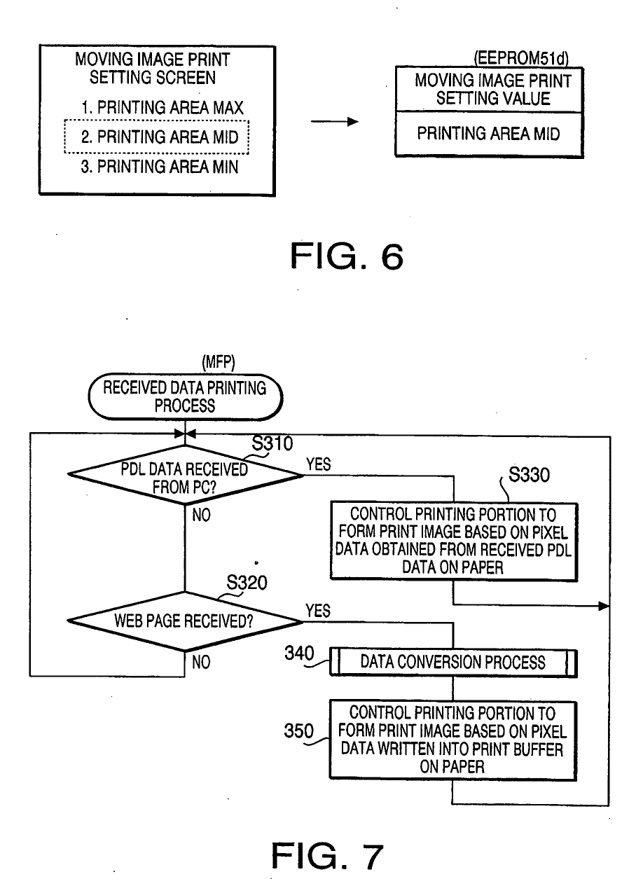

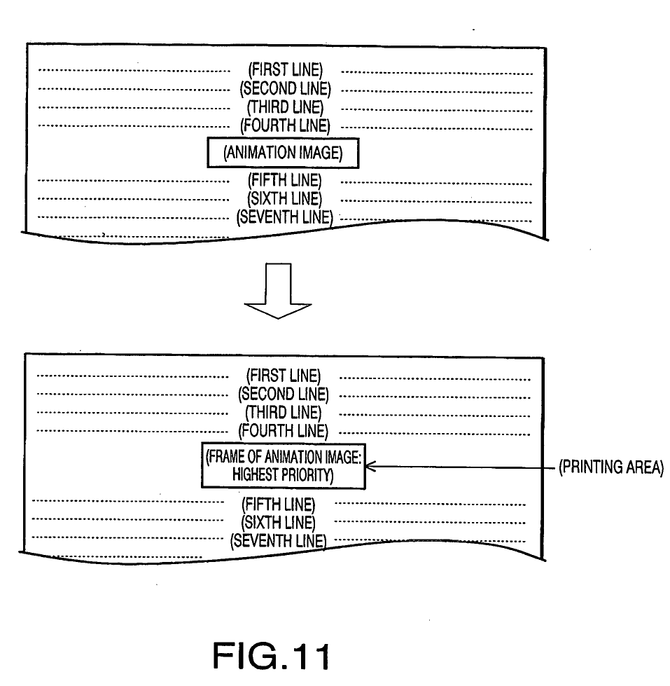

In the meantime, when the CPU 51a does not judge that the provided operation is for obtaining a web page (S120: No), the process goes to a step of S140 to judge whether the user operation provided through the operating portion 59 is for displaying a moving image print setting screen image (see a left illustration in FIG. 6). It is noted that the MFP 50 in the illustrative aspect has three print modes in printing the web page, namely, a “printing area MIN” mode where a representative image is printed on the printing paper as a print image corresponding to the animation image data incorporated in the web page, “printing area MID” mode where a line of still images included in the moving image are printed on the printing paper, and “printing area MAX” mode where all of the still images included in the moving image are printed on the printing paper (see FIGS. 11, 17, and 14). The moving image print setting screen is used for selecting one of the modes.

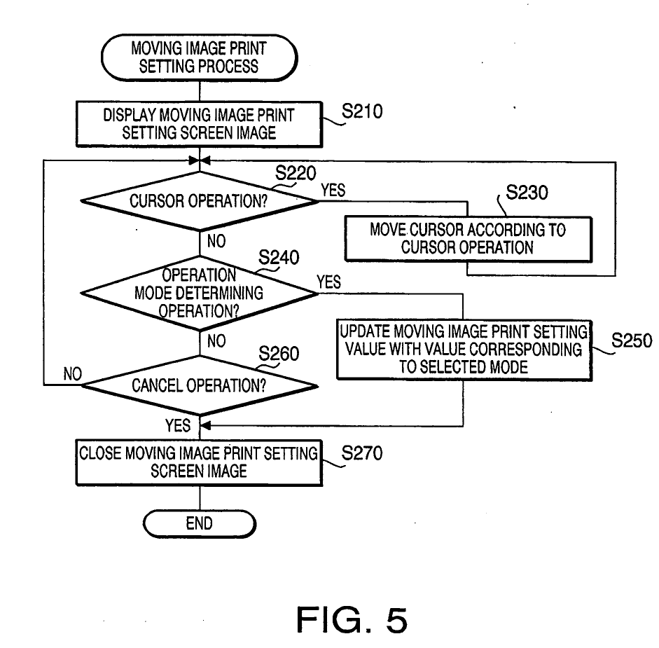

When it is judged that the provided operation is for displaying the moving image print setting screen image (S140: Yes), the CPU 51a executes a moving image print setting process as shown in FIG. 5 (S150). After completing the moving image print setting process, the process goes to the step of S110 to keep waiting ready until a next user operation is provided. In addition, when it is not judged that the provided operation is for displaying the moving image print setting screen image (S140: No), after executing another process corresponding to the provided user operation (S160), the process goes to the step of S110 to keep waiting ready until a next user operation is provided.

Subsequently, the moving image print setting process to be executed by the CPU 51a in the process of S150 will be explained. FIG. 5 is a flowchart showing the moving image print setting process to be executed by the CPU 51a. When starting the moving image print setting process, the CPU 51a displays the moving image print setting screen image configured as shown at the left side of FIG. 6 on the display portion 57 in a step of S210. In addition, after completing this step, the process goes to a step of S220 to judge whether a cursor operation has been provided by the user through the operating portion 59. When it is judged that a cursor operation has been provided (S220: Yes), an operation for moving the cursor displayed on the moving image print setting screen based on the cursor operation is performed (S230). It is noted that there are provided on the moving image print setting screen items for setting the operation mode in the “printing area MAX” mode, “printing area MID” mode, and “printing area MIN” mode, respectively. The cursor is moved from one of the items to another. When the cursor is moved in the step of S230, the process goes to the step of S230.

Meanwhile, when it is not judged that the cursor operation is provided by the user (S220: No), the process goes to a step of S240 to judge whether an operation mode determining operation has been provided by the user through the operating portion 59. When it is judged that the operation mode determining operation has been provided (S240: Yes), the process goes to a step of S250 to update a moving image print setting value stored in the EEPROM 51d with a value corresponding to an item to which the cursor currently points on the moving image print setting screen. Thereby, the operation mode of the MFP 50 is changed.

It is noted that there is stored in the EEPROM 51d as the moving image print setting value one of values representing the “printing area MAX” mode, “printing area MID” mode, and “printing area MIN” mode, respectively. In the step of S250, the moving image print setting value is changed in accordance with a location of the cursor.

In addition, after completing the step of S250, the CPU 51a terminates displaying the moving image print setting screen image (S270), and ends the moving image print setting process. Further, when it is not judged that the operation mode determining operation has been provided (S240: No), it is judged whether a cancel operation has been provided by the user (S260). When it is not judged that the cancel operation has been provided (S260: No), the process goes to the step of S220. Meanwhile, when it is judged that the cancel operation has been provided (S260: Yes), the process goes to the step of S270 to end the moving image print setting process after terminating displaying the moving image print setting screen image.

Subsequently, a received data printing process to be executed by the CPU 51a of the MFP 50 in parallel with the operation accepting process will be explained. FIG. 7 is a flowchart showing the received data printing process to be started by the CPU 51a of the MFP 50 when booting the MFP 50.

After starting the received data printing process, the CPU 51a receives the PDL data from the PC 30 through the communication portion 55 (S310), or keeps waiting ready until receiving a web page from the web server 10 through the communication portion 55 as response data to the web page request command in the step of S130 (S320). Then, when the CPU 51a receives the PDL data from the PC 30 via the communication portion 55 (S310: Yes), the process goes to a step of S330. In the step of S330, the CPU 51a converts the received PDL data into pixel data (bit map data), writes the pixel data into a print buffer provided in the RAM 51c, and controls the printing portion 61 to make the printing portion 61 form a print image based on the PDL data on a printing paper in accordance with the pixel data stored in the print buffer. Thereafter, the process goes to a step of S310 to keep waiting ready until one of PDL data and web page is received (S310, S320).

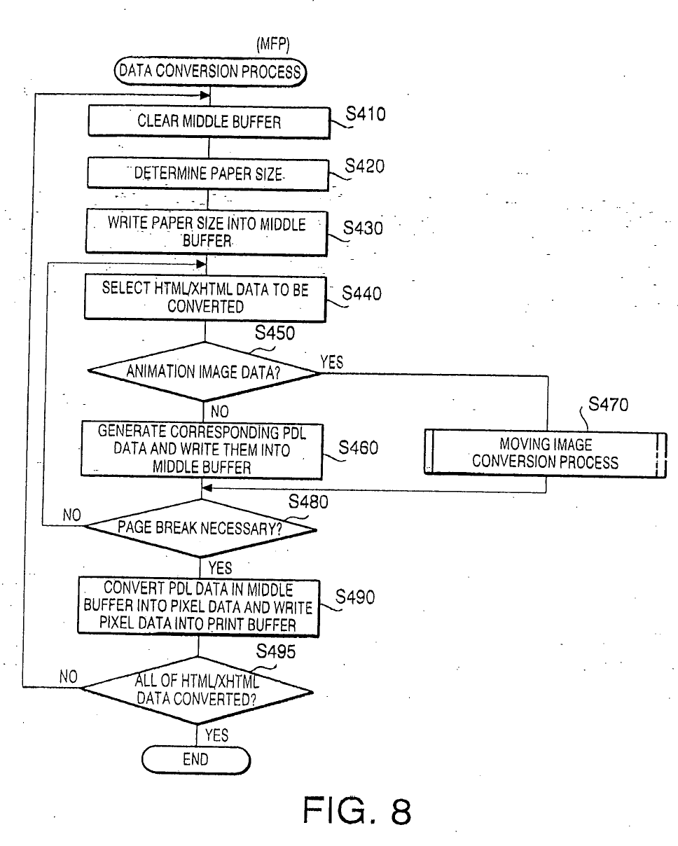

In the meantime, when the web page has been received from the web server 10 via the communication portion 55 (S320: Yes), the CPU 51a brings the process to a step of S340 to convert the web page into pixel data representing a print image for each paper (page) by executing a data conversion process shown in FIG. 8 and write the pixel data into the print buffer. Then, after completing the data conversion process in the step of S340, according to the pixel data for each page representing the print image of the web page stored in the print buffer, the CPU 51a controls the printing portion 61 to form the print image based on the pixel data for each page on a printing paper (S350). Thereafter, the process goes to the step of S310 to keep waiting ready until one of PDL data and web page is received (S310, S320).

Subsequently, the data conversion process to be executed by the CPU 51a in the step of S340 will be described. FIG. 8 is a flowchart showing the data conversion process to be executed by the CPU 51a. After starting the data conversion process, the CPU 51a clears a middle buffer for generating the PDL data provided in the RAM 51c (S410), and thereafter identifies a paper size previously set by the user to decide the paper size as a paper size for forming the print image corresponding to the web page (S420). In addition, although it is not shown in any drawing, there is stored in the EEPROM 51d setting information regarding the paper size to be used in printing the web page, and the CPU 51a identifies the paper size set by the user on the basis of the setting information.

After completing the step of S420, the process goes to a step of S430, and the CPU 51a writes the paper size decided in the step of S420 into the middle buffer as the PDL data. Thereafter, the process goes to a step of S440. Further, in the step of S440, the CPU 51a selects one HTML/XHTML (eXtensible HyperText Markup Language) data as an object to be converted into the PDL data from a group of constituent elements (HTML/XHTML data) of the received web page in accordance with an order in which the HTML/XHTML data are described.

After completing the step of S440, the CPU 51a judges whether the HTML/XHTML data as an object to be converted are an image tag having the animation image data configured as above with the print priority information in its source (S450). When it is not judged that the object to be converted is an image tag having the animation image data in its source (S450: No), the CPU 51a converts the HTML/XHTML data as the object to be converted into the PDL data, and writes the PDL data into the middle buffer (S460).

Namely, in the step of S460, by registering the HTML XHTML data to be converted as the PDL data in the middle buffer, the CPU 51a writes information specifying images and a print area corresponding to the HTML/XHTML data to be converted in the middle buffer. It is noted that, in the step of S460, specifically, there are written as a pat of the PDL data coordinates of a print starting point on the printing paper, horizontal and vertical widths of the print area, a font and image data for the object to be printed.

In addition, after thus completing the step of S460, the process goes to a step of S480. Then, in the step of S480, it is judged whether a page break is necessary. When it is not judged that a page break is necessary (S480: No), the CPU 51a brings the process to the step of S440 to select one of unprocessed HTML/XHTML data as the object to be converted (S440), and again, judges whether the HTML/XHTML data to be converted are an image tag having the animation image data configured as above in its source (S450).

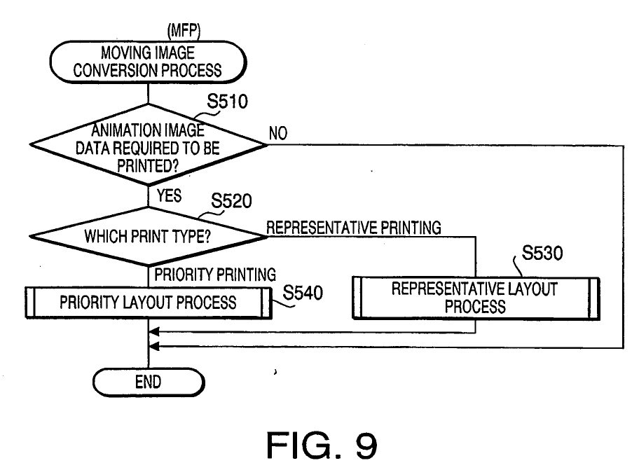

When it is not judged that the HTML/XHTML data to be converted are an image tag having the animation image data configured as above in its source (S450: No), the aforementioned steps of S460 and S480 are executed. Meanwhile, when it is judged that the HTML/XHTML data to be converted are an image tag having the animation image data configured as above in its source (S450: Yes), the CPU 51a brings the process to a step of S470 to execute a moving image conversion process as shown in FIG. 9.

Although the moving image conversion process in the step of S470 will be described in detail below, in the moving image conversion process, the CPU 51a generates the PDL data for forming the print images corresponding to one or more still image data included in the animation image data with being arranged on the printing paper as the print image corresponding to the animation image data, and writes the generated PDL data into the middle buffer.

Then, after completing the moving image conversion process in the step of S470, the CPU 51a brings the process to a step of S480 to judge whether the page break is necessary. When it is judged that the page break is necessary (S480: Yes), the CPU 51a brings the process to a step of S490 to convert a paper (page) of PDL data stored in the middle buffer into the pixel data (bit map data) and write the pixel data into the print buffer.

Further, after completing the step of S490, the CPU 51a judges whether all of the HTML/XHTML data constituting the web page are converted into the pixel data (S495). When it is not judged that all of the HTML/XHTML data are converted into the pixel data (S495: No), the process goes to the step of S410. In the step of S410, the CPU 51a once clears the middle buffer. In the following steps of S420 to S490, the CPU 51a generates a paper (page) of subsequent PDL data, and converts the PDL data into the pixel data. Meanwhile, when it is judged that all of the HTML/XHTML data constituting the web page are converted into the pixel data (S495: Yes), the CPU 51a terminates the data conversion process.

Subsequently, the moving image conversion process to be executed by the CPU 51a in the step of S470 will be explained. FIG. 9 is a flowchart showing the moving image conversion process to be executed by the CPU 51a. After starting the moving image conversion process, the CPU 51a reads animation image data (animation image data as an object to be converted) shown as a source in the HTML/XHTML data to be converted, and judges whether the animation image data to be converted are required to be printed based on the print assignment information included in the animation image data (S510).

In other words, when the aforementioned print assignment information represents that the animation image data are required to be printed, the CPU 51a, in the. step of S510, judges that the animation image data to be converted are animation image data required to be printed (S510: Yes). Meanwhile, when the print assignment information does not represent that the animation image data are required to be printed, the CPU 51a does not judge that the animation image data to be converted are animation image data required to be printed (S510: No).

When judging that the animation image data to be converted are not animation image data required to be printed (S510: No), the CPU 51a terminates the moving image conversion process.

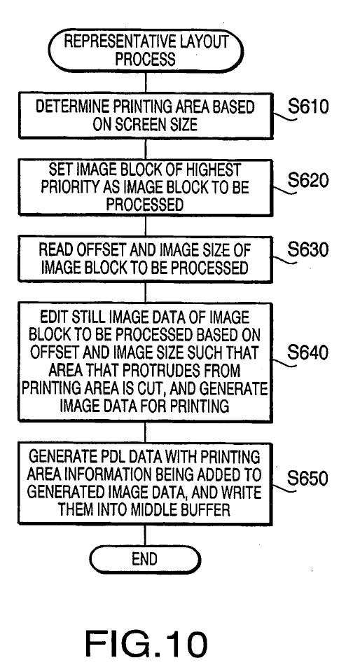

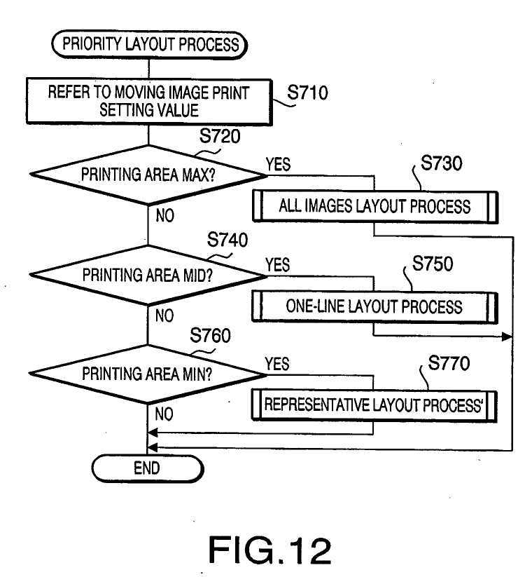

On the other hand, when judging that the animation image data to be converted are animation image data required to be printed (S510: Yes), the CPU 51a brings the process to a step of S520 to identify the printing method specified for the animation image data to be converted on the basis of the print type information. Then, when judging that the specified printing method is the “representative print”, the CPU 51a brings the process to a step of S530 to execute a “representative layout process” as shown in FIG. 10, and thereafter terminates the moving image conversion process. In the meantime, when judging that the printing method specified for the animation image data to be converted is the “priority print”, the CPU 51a brings the process to a step of S540 to execute a “priority layout process” as shown in FIG. 12, and thereafter terminates the moving image conversion process.

FIG. 10 is a flowchart showing the representative layout process to be executed by the CPU 51a in the step of S530. When starting the representative layout process, the CPU 51a, in a step of S610, decides the printing area to be assigned to the animation image data to be converted based on the screen size information included in the animation image data to be converted and a display layout of the web page.

It is noted that there is shown in the upper portion of FIG. 11 an illustration exemplifying a display location of the animation image data on the display screen of the web page. Meanwhile, there is shown in the lower portion of FIG. 11 an illustration representing a printing area corresponding to the display location. Namely, in the step of S610, the CPU 51a decides an area with vertical and horizontal widths corresponding to the screen size on the printing paper corresponding to the display location of the animation image data as the printing area to be assigned to the animation image data to be converted.

After completing the step of S610, the CPU 51a brings the process to a step of S620 to set, as an image block to be processed, an image block of the highest priority represented by the print priority information among the image blocks constituting the animation image data to be converted. Then, after completing the step of S620, the CPU 51a reads out the offset information and image size information of the image block to be processed (S630), and edits the still image data of the image block to be processed on the basis of the offset information and image size information read out, so as to generate still image data for printing (S640).

Namely, in the step of S640, a partial area of the still image data, which protrudes from the printing area when laying out the still image data as being shifted from a base point in the printing area in accordance with the offset information of the image block in the same printing area as the screen size, is appropriately cut such that the still image data can be laid out within the printing area without any portion thereof protruding from the printing area.

Then, after completing the step of S640, the CPU 51a adds the information regarding the printing area (the coordinates of the print starting point, and the horizontal and vertical widths of the printing area) decided in the step of S610 to the still image data generated in the step of S640, and generates the PDL data corresponding to the animation image data to be converted, so as to write the generated PDL data into the middle buffer (S650). Thereafter, the representative layout process is terminated.

Further, FIG. 12 is a flowchart showing the priority layout process to be executed by the CPU 51a in the step of S540. After starting the priority layout process, the CPU 51a, in a step of S710, refers to the moving image print setting value stored in the EEPROM 51d, and judges, based on the moving image print setting value, whether the operation mode related to printing of the moving image is set in the “printing area MAX” mode (S720). Namely, in the step of S720, it is judged whether the moving image print setting value is a value corresponding to the “printing area MAX” mode.

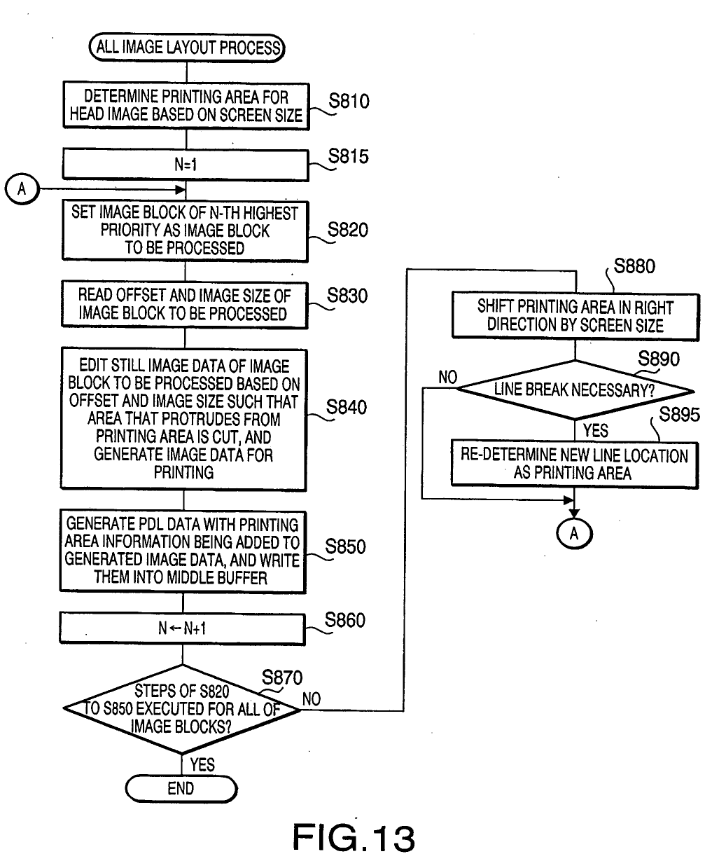

When it is judged that the operation mode is the “printing area MAX” mode (S720: Yes), the CPU 51a brings the process to a step of S730 to execute an all images layout process as shown in FIG. 13. Then, after completing the all images layout process, the priority layout process is terminated.

Meanwhile, when judging that the operation mode is not the “printing area MAX” mode (S720: No), the CPU 51a brings the process to a step of S740 to judge whether the operation mode is the “printing area MID” mode. Namely, in the step of S740, it is judged whether the moving image print setting value is a value corresponding to the “printing area MID” mode.

When judging that the operation mode is the “printing area MID” mode (S740: Yes), the CPU 51a brings the process to a step of S750 to execute a one-line layout process. After completing the one-line layout process, the priority layout process is terminated.

Further, when judging that the operation mode is not the “printing area MID” mode (S740: No), the CPU 51a brings the process to a step of S760 to judge whether the operation mode is the “printing area MIN” mode. Namely, in the step of S760, it is judged whether the moving image print setting value is a value corresponding to the “printing area MIN” mode.

When judging that the operation mode is the “printing area MIN” mode (S760: Yes), the CPU 51a brings the process to a step of S770 to execute the representative layout process. After completing the representative layout process in the step of S770, the priority layout process is terminated. On the other hand, when it is not judged that the operation mode is the “printing area MIN” mode (S760: No), the CPU 51a terminates the priority layout process.

FIG. 13 is a flowchart showing the all images layout process to be executed by the CPU 51a in the step of S730. After starting the all images layout process, the CPU 51a, in a step of S810, determines the printing area to be assigned to the animation image data to be converted on the basis of the screen size information included in the animation image data to be converted.

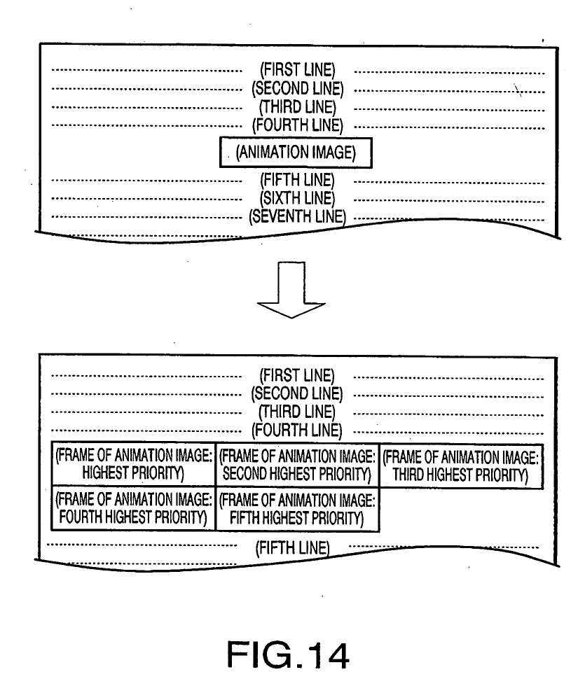

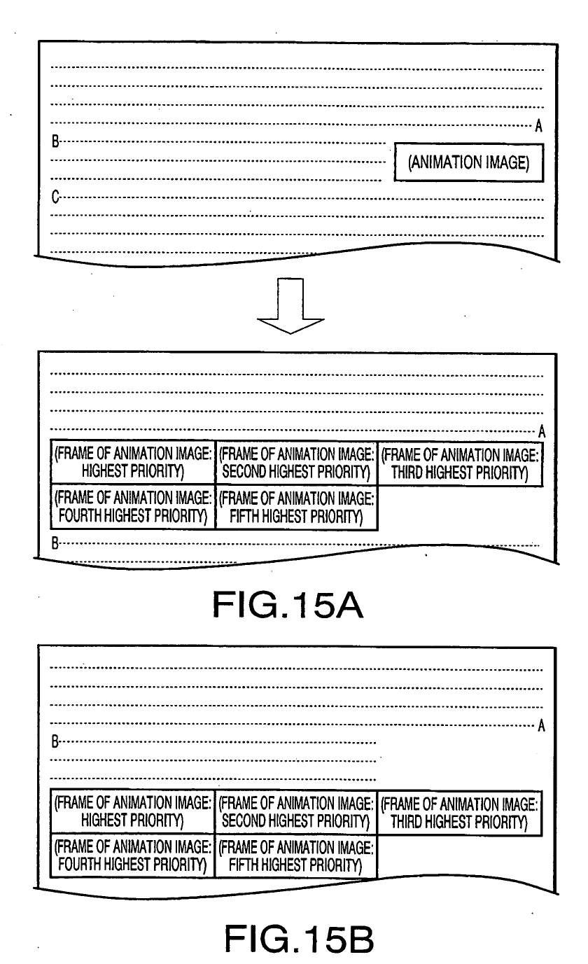

There is shown in the upper portion of FIG. 14 an illustration exemplifying a display location of the animation image data on the display screen of the web page. There is shown in the lower portion of FIG. 14 an illustration representing a printing area of the animation image data corresponding to the display location. In the same manner, there is shown in the upper portion of FIG. 15A an illustration exemplifying a display location of the animation image data on the display screen of the web page. Meanwhile, there is shown in the lower portion of FIG. 15A an illustration representing a printing area of the animation image data corresponding to the display location. In addition, FIG. 15B is an illustration showing another example of a printing area of the animation image data corresponding to the display layout of the web page as shown in the upper portion of FIG. 15A.

Specifically, in the step of S810, the CPU 51a determines, as the printing area to be assigned to the animation image data to be converted, an area with vertical and horizontal widths corresponding to the screen size on the printing paper on the basis of a head location of a line corresponding to the display location of the animation image data. Further, as another example, in the step of S810, when the area on the printing paper on the basis of the head location of the line corresponding to the display location of the animation image data has already been assigned as an printing area for PDL data corresponding to another HTML/XHTML data, the CPU 51a determines, as the printing area for the animation image data to be converted, a lower area than the area for the PDL data on the printing paper on the basis of a head location of a line.

Further, after thus completing the step of S810, the CPU 51a brings the process to a step of S815 to set a parameter N as N=1. After completing the step of S815, the process goes to a step of S820, and the CPU 51a sets an image block of the N-th highest priority represented by the print priority information among the image blocks constituting the animation image data to be converted as an image block to be processed.

After completing the step of S820, the CPU 51a reads out the offset information and image size information included in the image block to be processed (S830), and edits the still image data of the image block to be processed based on the offset information and image size information read out, so as to generate still image data for printing (S840). It is noted that a method of generating the still image data for printing is the same as that in the step of S640.

After completing the step of S840, the CPU 51a generates PDL data corresponding to the aforementioned still image data by adding the information (the coordinates of the print starting point, and the horizontal and vertical widths of the printing area) regarding the printing area determined in the step of S810, S880, or S895 to the still image data generated in the step of S840, and writes the PDL data into the middle buffer (S850).

In addition, after completing the step of S850, the CPU 51a brings the process to a step of S860, and increments the value of the parameter N by one to update the value of the parameter(NE←N+1). Then, after completing the step of S860, the CPU 51a judges whether the steps of S820 to S850 have been executed for all of the image blocks of the animation image data to be converted by checking whether the value of the parameter N exceeds the number of frames (the number of the image blocks) of the animation image data to be converted. When it is not judged that the steps of S820 to S850 have been executed (S870: No), the process goes to a step of S880, and the CPU 51a shifts the currently determined printing area in the right direction by the screen size to re-determine a right area adjacent to the currently determined printing area as a new printing area.

In addition, after completing the step of S880, the CPU 51a brings the process to a step of S890, and judges whether a line break is necessary by checking whether the re-determined printing area exceeds a right end of a printable area on the printing paper. When judging that the line break is not necessary (S890: No), the CPU 51a brings the process to the step of S820 without executing a step of S895. Meanwhile, when judging that the line break is necessary (S890: Yes), the CPU 51a brings the process to the step of S895 to re-determine a new line location as the printing area, and thereafter, the process goes to the step of S820.

When the process thus proceeds to S820, the CPU 51a executes subsequent steps, so as to generate PDL data by adding information regarding the printing area re-determined in the step of S880 or S895 to the still image data for printing corresponding to the still image data of the N-th highest priority and write the PDL data into the middle buffer (S850). Then, by repeating the aforementioned steps, in the all images layout process, PDL data are generated in the middle buffer such that the still image data constituting the animation image data to be converted are printed as being arranged in sequence from still image data of a higher priority. When judging that the steps of S820 to S850 have been executed for all of the image blocks (S870: Yes), the CPU 51a terminates the all images layout process.

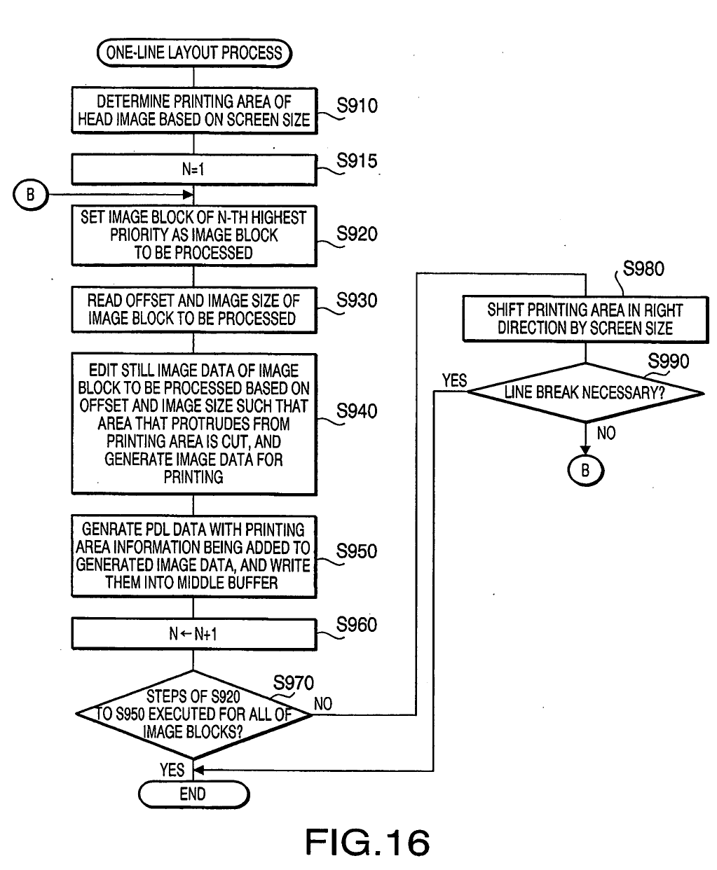

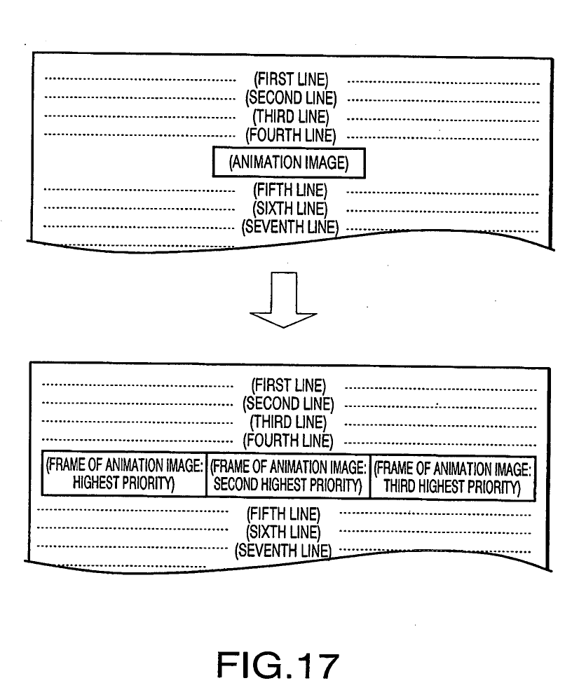

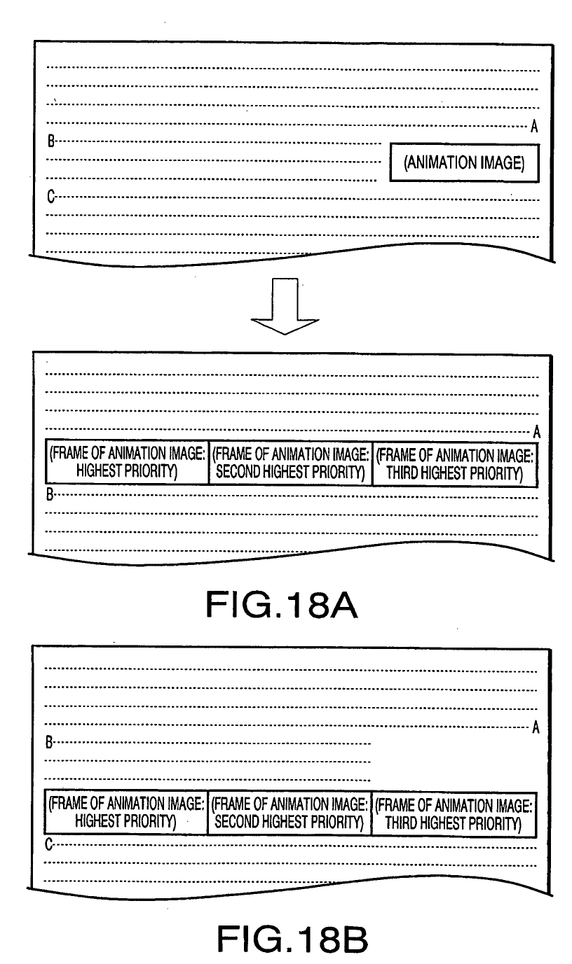

FIG. 16 is a flowchart showing the one-line layout process to be executed by the CPU 51a in the step of S750. After starting the one-line layout process, in a similar manner to the all images layout process, in a step of S910, the CPU 51a determines the printing area to be assigned to the animation image data to be converted based on the screen size information included in the animation image data to be converted. It is noted that there is shown in the upper portion of FIG. 17 an illustration exemplifying a display location of the animation image data on the display screen of the web page. Meanwhile, there is shown in the lower portion of FIG. 17 an illustration representing a printing area for the animation image data corresponding to the display location. In the same way, there is shown in the upper portion of FIG. 18A an illustration exemplifying a display location of the animation image data on the display screen of the web page. Meanwhile, there is shown in the lower portion of FIG. 18A an illustration representing a printing area for the animation image data corresponding to the display location. there is shown in the upper portion of FIG. 17 an illustration exemplifying a display location of the animation image data on the display screen of the web page. In addition, FIG. 18B is an illustration representing another example of a printing area for the animation image data corresponding to the display location shown in the upper portion of FIG. 18A.

Specifically, in the step of S910, the CPU 51a determines, as the printing area to be assigned to the animation image data to be converted, an area with vertical and horizontal widths corresponding to the screen size on the printing paper on the basis of a head location of a line corresponding to the display location of the animation image data. Further, as another example, in the step of S910, when the area on the printing paper on the basis of the head location of the line corresponding to the display location of the animation image data has already been assigned as an printing area for PDL data corresponding to another HTML/XHTML data, the CPU 51 a determines, as the printing area for the animation image data to be converted, a lower area than the area for the PDL data on the printing paper on the basis of a head location of a line.

In addition, after thus completing the step of S910, the CPU 51a brings the process to a step of S915 to set the parameter N as N=1. Further, after the step of S915, the process goes to a step of S920, and the CPU 51a sets an image block of the N-th highest priority represented by the print priority information among the image blocks constituting the animation image data to be converted as an image block to be processed.

After completing the step of S920, the CPU 51a reads out the offset information and image size information included in the image block to be processed (S930), and edits the still image data of the image block to be processed based on the offset information and image size information read out, so as to generate still image data for printing (S940). It is noted that a method of generating the still image data for printing is the same as that in the step of S640.

After completing the step of S940, the CPU 51a generates PDL data corresponding to the aforementioned still image data by adding the information (the coordinates of the print starting point, and the horizontal and vertical widths of the printing area) regarding the printing area determined in the step of S910, or S980 to the still image data generated in the step of S940, and writes the PDL data into the middle buffer (S950).

In addition, after completing the step of S950, the CPU 51a brings the process to a step of S960, and increments the value of the parameter N by one to update the value of the parameter (N←N+1). Then, after completing the step of S860, the CPU 51a judges whether the steps of S920 to S950 have been executed for all of the image blocks of the animation image data to be converted. When it is not judged that the steps of S920 to S950 have been executed (S970: No), the process goes to a step of S980, and the CPU 51a shifts the currently determined printing area in the right direction by the screen size to re-determine a right area adjacent to the currently determined printing area as a new printing area.

In addition, after completing the step of S980, the CPU 51a brings the process to a step of S90, and judges whether a line break is necessary by checking whether the re-determined printing area exceeds a right end of a printable area on the printing paper. When judging that the line break is not necessary (S990: No), the CPU 51a brings the process to the step of S920. In the step of S950, the CPU 51a generates PDL data by adding information regarding the printing area re-determined in the step of S980 to the still image data for printing corresponding to the still image data of the N-th highest priority, and writes the PDL data into the middle buffer.

Meanwhile, when judging that the line break is necessary in the step of S990 (S990: Yes), or when judging that the steps of S920 to S950 have been executed for all of the image blocks in the step of S970 (S970: Yes), the CPU 51a terminates the one-line layout process.

Namely, in the one-line layout process, by repeating the steps of S920 to S990, PDL data are generated in the middle buffer such that the still image data constituting the animation image data to be converted are printed as being arranged by a line of images in sequence from still image data of a higher priority.

Hereinabove, the explanation on the communication system 1 has been given. According to the communication system 1, the CPU 51a of the MFP 50 obtains a web page (e.g., a web page into which the animation image data configured as above are incorporated) specified by a URL designated by the user from the web server 10 that stores the web page.

Further, in the MFP 50, in the case where each constituent element (HTML/XHTML data) of the obtained web page is converted into the PDL data, when detecting an image tag having the animation image data configured as above with the print priority information in its source (S450: Yes), the CPU 51a selects a predetermined amount of still image data in sequence from still image data of a higher priority among the still image data included in the animation image data (S620, S820, S920), and generates such PDL data that print images corresponding to the selected still image data are arranged on the printing paper as the print images corresponding to the animation image data (S650, S850, S950).

Then, in the MFP 50, after converting the PDL data into the pixel data, by making the printing portion 61 form the print image based on the pixel data, the CPU 51a forms the print image on the printing paper such that one or more still images included in the animation image data are arranged in sequence from a still image of a higher priority (S350).

Thus, according to the communication system 1 in the illustrative aspect, the still image of a higher priority represented by the print priority information is preferentially formed on the printing paper as an image corresponding to the animation image data included in the web page. Therefore, an image that a creator of the animation image data especially considers important can preferentially be formed on the printing paper. Namely, a message that the creator wishes to convey in the animation image data can be conveyed to the user even with the printing paper on which the animation image data have been printed. Hence, according to the communication system 1, even though the web page has been printed on the printing paper, for example, there is expected in the printed paper sufficient advertising effectiveness of a product introduced in the web page on the user.

Especially, according to the illustrative aspect, even though the images corresponding to all of the still image data constituting the animation image data are not formed on the printing paper, the message that the creator of the animation image data wishes to convey can be conveyed, for example, with the one-line printing. Namely, the message represented by the animation image data can efficiently be conveyed to the user with the printed paper without wasting a space on the printing paper.

Further, in the illustrative aspect, by changing the operation mode in accordance with the user operation of the operating portion 59, an amount of the still images to be printed as images corresponding to the animation image data can be changed based on the user's instruction (S150). Therefore, according to the aspect, the still images of an amount to meet user's requirements can be formed on the printing paper as images corresponding to the animation image data. In other words, according to the aspect, the user can adjust the amount of the images to be printed corresponding to the animation image data by changing the setting of the operation mode.

In the meantime, in the aforementioned aspect, there has been explained an example of the MFP 50 provided with the web page printing function that is configured to select some of the still image data constituting the animation image data as the print image corresponding to the animation image data, and to form the print image based on the still image data on the printing paper. However, at least functions up to generating the PDL data as aforementioned may be actualized in the PC 30.

Modification

Hereinafter, there will be explained a communication system 1 configured such that the PC 30 generates PDL data corresponding to the animation image data in the same manner as the aforementioned aspect. It is noted that, since such a function is actualized in a browser process to be executed by the CPU 31a of the PC 30 with software, hereinafter, there will be explained only the browser process to be executed by the CPU 31a of the PC 30 based on the browser stored in the storing portion 33, and constituent element of the modification configured in the same manner as the aforementioned aspect will be omitted.

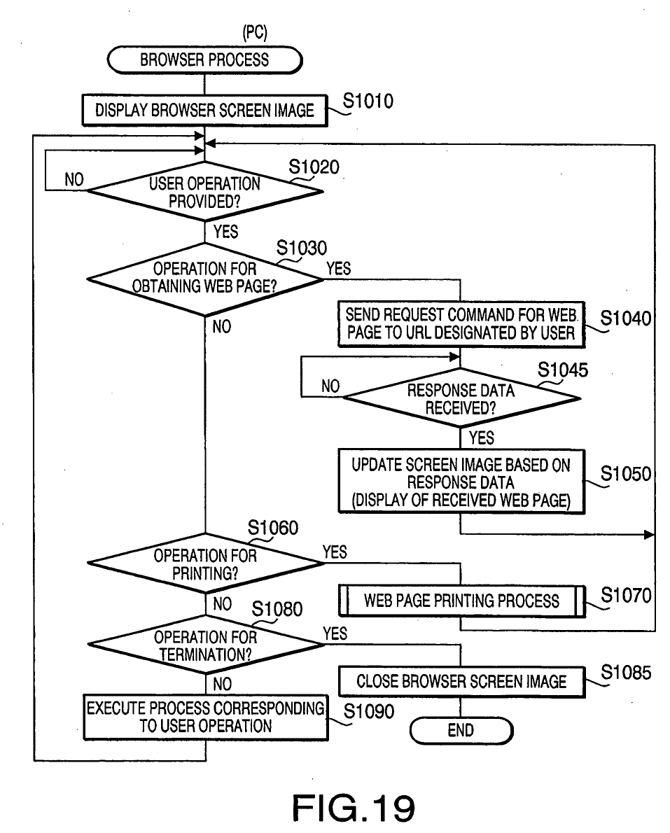

FIG. 19 is a flowchart showing the browser process to be executed by the CPU 31a based on the browser stored in the storing portion 33 in response to a boot instruction for booting the browser being inputted with the operating portion 39 being operated by the user.

After starting the browser process, the CPU 31a, firstly in a step of S1010, displays a browser screen image configured as a GUI (Graphical User Interface) with icons for operations and the like on the display portion 37. After completing the step of S1010, the CPU 31a keeps waiting ready until an operation on the browser screen is given by the user through the operating portion 39 (S1020). When an operation on the browser has been given (S1020: Yes), the process goes to a step of S1030. Further, when the given operation is an operation for obtaining a web page (S1030: Yes), a request command for requesting a web page specified by a URL designated by the user through the operation is sent to the web server 10 specified by the URL via the communication portion 35 (S1040). Thereafter, the CPU 31a keeps waiting ready until receiving response data corresponding to the request command sent via the internet and communication portion 35 (S1 045).

Then, when having received the response data (S1045: Yes), the CPU 31a brings the process to a step of S1050 to update the browser screen based on the received response data. Namely, when having received the web page as the response data from the web server 10, the CPU 31a displays a screen image corresponding to the web page in the browser screen image. On the other hand, when having received an error message, the CPU 31a displays an screen image corresponding to the error message in the browser screen image. In addition, after completing the step of S1050, the CPU 31a brings the process to the step of S1020, and keeps waiting ready until a next operation is given.

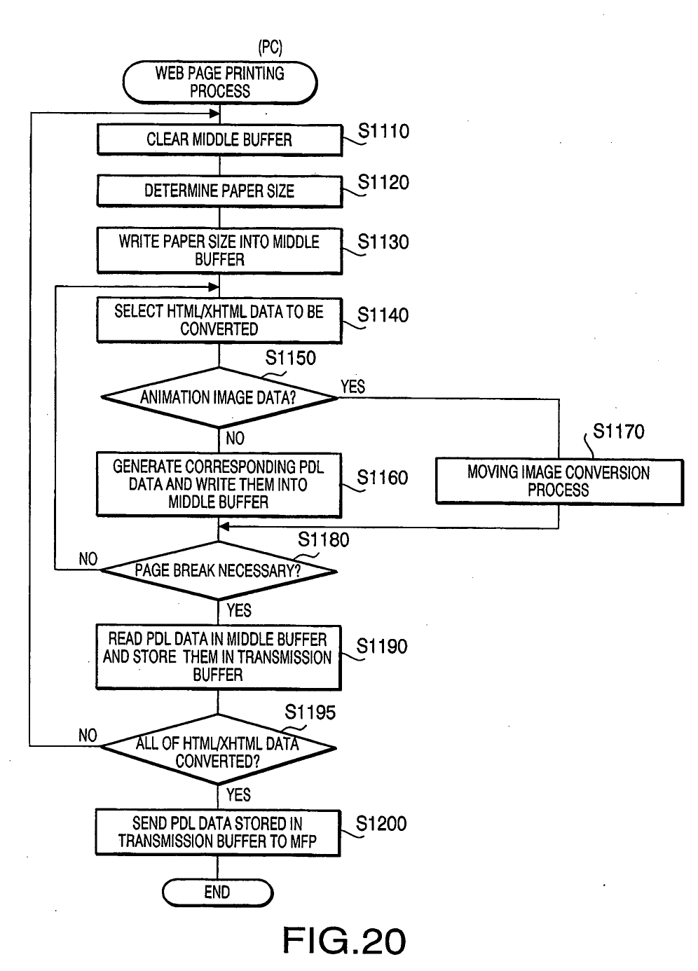

Meanwhile, when the operation on the browser is not an operation for obtaining a web page (S1030: No), but an operation for printing (S1060: Yes), the CPU 31a brings the process to a step of S1070 to execute a web page printing process as shown in FIG. 20. FIG. 20 is a flowchart showing the web page printing process to be executed by the CPU 31a

After starting the web page printing process, the CPU 31a clears the middle buffer provided in the RAM 31c for generating PDL data (S1110). Thereafter, the CPU 31a identifies a paper size previously set by the user, and determines the paper size as a paper size for forming a print image corresponding to the web page (S1120). It is noted that it is not shown in any drawing, yet there is stored in the storing portion 33 setting information regarding a paper size used when printing the web page and the CPU 31a identifies the paper size set by the user based on the setting information.

After completing the step of S1120, the CPU 31a brings the process to a step of S1130 to write the paper size determined in S1120 as PDL data into the middle buffer. Thereafter, the process goes to a step of S1140. Further, in the step of S1140, the CPU 31a selects one of constituent elements (HTML/XHTML data) of the web page displayed in the browser screen in accordance with an order in which the HTML/XHTML data are described.

Then, after completing the step of S1140, the CPU 31a judges whether the HTML/XHTML data as an object to be converted are an image tag having the animation image data configured with the print priority information in its source (S1150). When it is not judged that the object to be converted is an image tag having the animation image data in its source (S1150: No), the CPU 31a converts the HTML/XHTML data to be converted into the PDL data, and writes the PDL data into the middle buffer (S160).

In addition, after thus completing the step of S1160, the CPU 31a brings the process to a step of S1180, and then, judges whether a page break is necessary. When it is not judged that a page break is necessary (S1180: No), the CPU 31a brings the process to the step of S1140 to select one of unprocessed HTML/XHTML data as an object to be converted, and again, it is judged whether the HTML/XHTML data to be converted are an image tag having the animation image data configured in its source (S1150).

Then, when it is judged that the HTML/XHTML data to be converted are an image tag having the animation image data configured as above in its source (S1150: Yes), the CPU 31a brings the process to a step of S1170 to execute the moving image conversion process.

Further, in the step of S1170, the moving image conversion process shown in FIG. 9 is executed by the CPU 31a using the RAM 31c as a working memory. It is noted that an operation of referring to the moving image print setting value stored the EEPROM 51d, as aforementioned, is performed in the priority layout process to be executed in S540, while, as substitute for such processing, an operation of referring to the moving image print setting value stored the storing portion 33 is performed in the priority layout process to be executed in S1170. In other words, the PC 30 is provided with the same function as that for the moving image print setting process shown in FIG. 5, and in the modification, there is stored in the storing portion 33 the moving image print setting value to be updated by the function.

Then, after completing the moving image conversion process in S1170, the CPU 31a brings the process to a step of S1180 to judge whether a page break is necessary. When it is judged that the page break is necessary (S1180: Yes), the CPU 31a brings the process to a step of S1190 to write a paper (page) of PDL data stored in the middle buffer into a transmission buffer.

Further, after completing the step of S1190, the CPU 31a judges whether all of the HTML/XHTML data constituting the web page are converted into the PDL data (S1195). When it is not judged that all of the HTML/XHTML data are converted into the PDL data (S1195: No), the process goes to the step of S1110. In the step of S1110, the CPU 31a once clears the middle buffer. In the following steps of S1120 to S1190, the CPU 31a generates a paper (page) of subsequent PDL data. Meanwhile, in the step of S1195, when it is judged that all of the HTML/XHTML data constituting the web page are converted into the PDL data (S1195: Yes), the CPU 31a brings the process to a step of S1200, and makes the MFP 50 form a print image based on the PDL data on the printing paper for each of the pages by sending the PDL data for each of the papers (pages) stored in the transmission buffer to the MFP 50 at the same time. Then, after completing the step of S1200, the web page printing process is terminated.

In addition, after completing the web page printing process in S1070, the CPU 31a bring the process to a step of S1020 to keep waiting ready until a next operation is given. Further, when the operation on the browser screen is not an operation for obtaining a web page or printing (S1030: No, S1060: No), but an operation for termination (S1080: Yes), the CPU. 31a brings the process to a step of S1085 to terminate displaying the browser screen and the browser process. Further, when an operation other than the aforementioned operations is given on the browser screen (S1080: No), processing corresponding to the given operation is executed (S1090). Then, after completing the step of S1090, the CPU 31a brings the process to the step of S1020.

Hereinabove, the modification has been explained. Even in the modification, the same effects as those brought by the aforementioned MFP 50 can be expected.

The present invention is not limited to the aforementioned aspect, and various sorts of modifications may be possible as far as they are within a technical scope which does not extend beyond a subject matter of the present invention. For example, in the aforementioned aspect, there are three operation modes, namely, the printing area MIN mode in which a representative image is printed on the printing paper among the still images included in the animation image data, the printing area MID mode in which a line of still images are printed on the printing paper among the still images included in the animation image data, and the printing area MAX mode in which all of the still images included in the animation image data are printed on the printing paper. However, in the MFP 50, there may be provided besides the operation modes, for example, an operation mode in which two lines of still images are printed on the printing paper among the still images included in the animation image data, or an operation mode in which still images of the highest priority and the second highest priority are printed on the printing paper among the still images included in the animation image data.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A print control system, comprising:
a data obtaining system configured to obtain moving image data from a storage device that stores the moving image data including a plurality of frame data corresponding to still images, each of the plurality of frame data to which priority information representing a priority is added;
a selecting system configured to select frame data to be printed based on the priority information added to each of the plurality of frame data among the plurality of frame data included in the moving image data;
a data conversion system configured to generate print image data with a print image corresponding to each of the frame data selected by the selecting system being arranged on a paper; and
a controlling system configured to control a printing device to form a print image based on the print image data generated by the data conversion system.

2. The print control system according to claim 1,
wherein the selecting system is configured to select a predetermined amount of frame data in sequence from frame data of a higher priority as frame data to be printed among the plurality of frame data included in the moving image data.

3. The print control system according to claim 1, further comprising:
a user interface configured to issue a signal in accordance with a user operation; and
a setting system configured to set an amount of frame data to be selected as frame data to be printed based on the signal issued from the user interface,
wherein the selecting system is configured to select frame data of the amount set by the setting system as frame data to be printed among the plurality of frame data included in the moving image data.

4. The print control system according to claim 2, further comprising:
a user interface configured to issue a signal in accordance with a user operation; and
a setting system configured to set an amount of frame data to be selected as frame data to be printed based on the signal issued from the user interface,
wherein the selecting system is configured to select frame data of the amount set by the setting system as frame data to be printed. among the plurality of frame data included in the moving image data.

5. The print control system according to claim 1,
wherein the selecting system is configured to select frame data of the highest priority as frame data to be printed among the plurality of frame data included in the moving image data.

6. A print control system, comprising:
a storage device configured to store contents data that include moving image data configured with a plurality of frame data corresponding to still images, priority information representing a priority being added to each of the plurality of frame data;
a data obtaining system configured to obtain moving image data from a storage device that stores contents data including the moving image data configured with a plurality of frame data corresponding to still images, each of the plurality of frame data to which priority information representing a priority is added;
a data detecting system configured to detect the moving image data configured with the plurality of frame data to which the priority information is added from the contents data obtained by the data obtaining system;
a selecting system configured to select frame data to be printed based on the priority information added to each of the plurality of frame data among the plurality of frame data included in the moving image data;
a data conversion system configured to generate print image data with a print image corresponding to each of the frame data selected by the selecting system from the plurality of frame data included in the moving image data as a print image representative of the moving image data detected by the data detecting system being arranged on a paper; and
a controlling system configured to control a printing device to form a print image based on the print image data generated by the data conversion system.

7. The print control system according to claim 6,
wherein the selecting system is configured to select a predetermined amount of frame data in sequence from frame data of a higher priority as frame data to be printed among the plurality of frame data included in the moving image data.

8. The print control system according to claim 6, further comprising:
a user interface configured to issue a signal in accordance with a user operation; and
a setting system configured to set an amount of frame data to be selected as frame data to be printed based on the signal issued from the user interface,
wherein the selecting system is configured to select frame data of the amount set by the setting system as frame data to be printed among the plurality of frame data included in the moving image data.

9. The print control system according to claim 7, further comprising:
a user interface configured to issue a signal in accordance with a user operation; and
a setting system configured to set an amount of frame data to be selected as frame data to be printed based on the signal issued from the user interface,
wherein the selecting system is configured to select frame data of the amount set by the setting system as frame data to be printed among the plurality of frame data included in the moving image data.

10. The print control system according to claim 6,
wherein the selecting system is configured to select frame data of the highest priority as frame data to be printed among the plurality of frame data included in the moving image data.

11. A computer usable medium comprising computer readable instructions that cause a computer to serve as:
a data obtaining system configured to obtain moving image data from a storage device that stores the moving image data including a plurality of frame data corresponding to still images, each of the plurality of frame data to which priority information representing a priority is added;
a selecting system configured to select frame data to be printed based on the priority information added to each of the plurality of frame data among the plurality of frame data included in the moving image data;
a data conversion system configured to generate print image data with a print image corresponding to each of the frame data selected by the selecting system being arranged on a paper; and
a controlling system configured to control a printing device to form a print image based on the print image data generated by the data conversion system.

12. A computer usable medium comprising computer readable instructions that cause a computer to serve as:
a storage device configured to store contents data that include moving image data configured with a plurality of frame data corresponding to still images, priority information representing a priority being added to each of the plurality of frame data;
a data obtaining system configured to obtain moving image data from a storage device that stores contents data including the moving image data configured with a plurality of frame data corresponding to still images, each of the plurality of frame data to which priority information representing a priority is added;
a data detecting system configured to detect the moving image data configured with the plurality of frame data to which the priority information is added from the contents data obtained by the data obtaining system;
a selecting system configured to select frame data to be printed based on the priority information added to each of the plurality of frame data among the plurality of frame data included in the moving image data;
a data conversion system configured to generate print image data with a print image corresponding to each of the frame data selected by the selecting system from the plurality of frame data included in the moving image data as a print image representative of the moving image data detected by the data detecting system being arranged on a paper; and
a controlling system configured to control a printing device to form a print image based on the print image data generated by the data conversion system.
